(19) United States
(12) Patent Application Publication
(10) Pub. No.: US 2008/0294981 A1
(43) Pub. Date: Nov. 27, 2008

(54) Page clipping tool for digital publications

(75) Inventors: Bertrand J. Balzano, Dallas, TX (US); Claudie Clot, Dallas, TX (US)

Correspondence Address: ADVANCIS.COM, INC, 2911 TRULTE CREEK BLVD , SUITE 300, DALLAS, TX, 75219, US

(73) Assignee: advancis.com, Inc., Dallas, TX (US)

(21) Appl. No.: 11/865,439

(22) Filed: Oct. 1, 2007

Related U.S. Application Data
(60) Provisional application No. 60/939,306, filed on May 21, 2007.

(51) Int. Cl. G06F 15/00

(52) U.S. Cl. 715/256

(57) ABSTRACT

Systems, methods, graphical user interface and other implementations are disclosed for capturing, saving, managing, and processing a plurality of sections of content of interest (e.g. page clippings) of a page or a plurality of pages from one or more digital publications based on the semantics of the content selected and or descriptive metadata attributes associated with the content selected and or semantically-rich description of information selected and or a combination thereof. The invention also consisting of user interface elements (e.g. publication components) that incorporate one or more tools (e.g. applications) that let the user perform specific tasks on the stored page clippings.

### REFERENCES

This application claims the benefit of U.S. Provisional Patent Application U.S.60/939,306, filed on May 21, 2007, entitled “Page clipping tool for digital publications”.

Other patents referenced in this application include:

U.S. Pat. No. 7,027,071 Apr. 11, 2006 Chao et al.

U.S. Patent Applications 20070106952 Sep. 1, 2006 Matas et al.

### BACKGROUND

1. Field of Invention

The present invention relates generally to digital publications that are displayed on the screen of a computer or on the screen of a mobile device or other display. While some digital publications are self-contained computer applications, others must be run using another application to function properly and to be displayed on screen. The present invention relates to both types of digital publications and therefore also relates to said applications that may be referred to as a reader, plug-in or other multimedia player.

The term Digital publication is meant to encompass digital brochures, digital magazines, digital catalogs, digital newspapers, ebooks, eBrochures. eMagazines, eCatalogs, eNewspapers, electronic brochures, electronic magazines, electronic catalogs, online brochures, online magazines, and online catalogs. The list represents a sample of the multitude of terms used in the marketplace to describe a digital publication and is in no way exhaustive.

2. Prior art

Digital publications have become increasingly popular and prevalent in today's marketplace thanks in part to publishers' and marketers' desire to save on printing and shipping costs over paper publications. The advent of the Internet has further increased the popularity of the digital publication format because new Internet-based distribution channels meant that the circulation and reach of a digital publication could rival or surpass that of its paper counterpart.

In its simplest form, a digital publication consists of a set of pages presented in a single- or double-page view on a computer screen or mobile device screen whereby the user can navigate through the publication using the mouse, keyboard or other input device, in effect, simulating the act of reading of a paper publication. In recent years, more elaborate digital publications have been introduced further mimicking actual paper publications on screen whereby the reader is actually able to turn pages of the publication in a 3D or 2D environment.

Users can perform some straightforward actions on the content of the publication such as copying a section of interest. However, in their present form, digital publications and digital publication readers still lack features allowing users to select, store, organize, reformat or process a plurality of separate sections of content (related or not) of interest based on the meaning and or descriptive metadata attributes of the content captured. Both the combination of sections of content and the processing of sections based on their meaning, description, and or explanation of the meaning greatly enhances the value of the resulting content because the user can customize, sort, reformat the content of the publication to better fit her informational needs or objectives or run the stored set of content sections through additional processes to further enhance its value. In other words, such capabilities can enhance the usability of the digital publication and usefulness of its content by allowing the user to achieve with greater convenience the purpose for which the digital publication was acquired/opened in the first place and or do more with the content.

There are a few techniques available for reusing a digital publication's content. However, the available techniques are complicated, limited in their scope, require extensive user interaction and force users to jump between applications to accomplish certain tasks. For example, a user reading a digital publication for a conference or trade show on her computer's display is unable to easily export a customized agenda to her mobile phone or iPod.™ without copying the section of text concerning a seminar of interest, pasting the information in another document, editing the information that is not needed, and repeating the tasks for every seminar or course of interest. Then she needs to reformat, by hand or using another authoring application, the content of the new document to include the appropriate code and tags that will make the document compatible with the mobile device. In this case, it is understood that someone reading a conference brochure intends to register for the event and build her schedule for the conference by choosing sessions, seminars or courses of interest.

In another situation, a user reading a travel brochure is not able to compose an itinerary by selecting the accommodations, attractions, or dinning establishments she wishes to visit during her trip because said accommodations, attractions or dining establishments are usually presented in a variety of formats in the brochure, such as video commercials, graphics-based ads, or text listings, making the creation of such itinerary too time-consuming and complicated for the average user. In this case, it is understood that a person reading a travel brochure seeks to assemble information to build an itinerary of her trip.

Presently, users' capabilities are limited because current page clipping tools or content extractor methods merely present clones of captured sections or fully-functional clipped view of the original content source, in other words, they can present a series of typographical elements such as letters and numbers of a sentence or pixels of a picture to the user but cannot process the content of the information selected. The current tools and methods can determine the content format of a page clipping but not its semantics, relevance, or relation to other content displayed in the page of the digital publication. For example, the tool will know that a user clipped a section that contained a video and display the video for play back in the clipping, but it will not be able to determine the meaning with the video content or describe the video content.

As a result, page clipping is usually reduced to displaying sections that have been saved by the user, in other words, rendering back to the user display only the section captured from a page or set of pages. Executing any kind of meaningful functions or processes on a page clipping or set of clippings is not possible. Enhancing the usefulness of the content presented in the digital publication is not possible. Enhancing the usability of the digital publication is very complicated.

Recent inventions (U.S. Pat. No. 7,027,071) related to selecting a plurality of logically related elements from an electronic document only provide means for automatically expanding the user's selection bounding box to include a group of related elements to be extracted from the document along with the original selected element. The result is a larger selection based on semantics affinity of the different related elements. Once the selection is made and content is copied to the OS clipboard application, no semantics or descriptive attributes are encoded in the clipping. The clipping only takes the form of a graphical representation of the selected area of content.

Other recent inventions (US patent application 20070106952) allow for the creation of clipped views of a page whereby the user can select a portion of a page and have the content associated with this portion presented, along with other clipped views on a clipping page (e.g. repository of clipped views). Each clipped view displays a view of the section of interest from the source page. The content of a view can be refreshed to reflect changes in the source page. However, the invention cannot determine or associate meaning with the content selected and lacks mechanisms for allowing the user to organize, sort or reformat content captured from a page.

Other applications, although not directly related to digital publications, allow users to add tags (e.g. keywords) to describe the content of a page clipping. These techniques allow the user to place category labels on the page clipping but do not allow for the processing of the content of information selected.

As such, users are in a way forced to accept the way the information is presented to them without being able to organize, classify, combine, reformat or select a plurality of related or unrelated content of interest.

Hence, enhancements to the user interface of digital publications and capabilities built in the publication or publication reader application (e.g. application used to display digital publication) are needed to give the user the option of organizing, combining, processing a plurality of sections of content of interest of said publications based on the meaning of content selected and or descriptive metadata attributes associated with the content selected or a combination thereof.

### SUMMARY OF THE INVENTION

Systems, methods, graphical user interface and other implementations are disclosed for capturing, saving, managing, and processing a plurality of sections of content of interest from a page (e.g. page clippings) or from a plurality of pages from a digital publication or from a plurality of digital publications based on the semantics of the content and or association of semantics with the content and or semantically-rich description of information or a combination thereof. The invention also consisting of user interface elements (e.g. publication components) located on or off the digital publication that include one or more tools (e.g., applications) that let the user perform specific tasks on and provide fast access to information about the set of page clippings collected. Said tasks can include, but are not limited to, depending on the function(s) of the component: organizing clippings; printing a customized, reformatted version of the digital publication(s) based on set of page clippings; formatting the metadata and information contained in or represented by page clippings to create a new document generated by a computer program locally on the user's own computer or mobile device or remotely on one or more server systems; sharing metadata from page clippings or content represented by page clippings with applications on remote servers or applications on user's own system for further processing or for completing a transaction; exporting the list of page clippings or content represented in clippings in a format compatible with mobile devices' applications; or downloading more information (e.g. information, files, data, etc . . . ) about the content captured in page clipping.

Content captured in a page clipping can be in any format including, but not limited to, text, video, audio, and graphical or a combination thereof.

A page clipping can contain a combination of the the actual content selected and semantic metadata/descriptive data associated with the content selected or part of the content selected and semantic metadata/descriptive data associated with the content selected or only semantic metadata/descriptive data associated with the content selected in which case none of the content in the selected area becomes part of the page clipping. In some implementations, a page clipping can contain more information than is presented in the selected section in the page of the digital publication. In some implementations, a page clipping is represented on screen by a text label, a user interface element, an icon, a graphical representation of the content selected or its metadata or a combination thereof.

### BRIEF DESCRIPTION OF THE DRAWINGS

FIG. 1 shows a screenshot of an exemplary desktop user interface with an exemplary digital publication.

FIG. 2 shows a block diagram of an exemplary page clipping tool which consists of several processes and engines

FIG. 3 shows a block diagram of a method for capturing, generating and storing a page clipping.

FIG. 4a shows a screenshot showing a page clipping preview icon being displayed to user as a result of selecting content on a page.

FIG. 4b represents a screenshot of a page clipping icon featuring a graphical element indicating that the page clipping cannot be added and has already been included in stored set.

FIGS. 4c,4d and 4e show the interaction between page clipping preview icon and publication component icon.

FIG. 4f shows exemplary dropzones displayed as a result of intersecting page clipping and publication component icons.

FIGS. 4g and 4h show exemplary interactions between page clipping preview icon and dropzones of publication component icon.

FIG. 5 shows a screenshot of an exemplary page clipping management user interface that can be displayed by the page clipping manager.

FIGS. 6a and 6b show screenshots of an exemplary publication component user interface.

FIG. 7a shows a block diagram of a method for ensuring that stored page clippings conform to requirements.

FIG. 7b shows a block diagram of a method for determining compatibility of functions of different publication components and subsequent display of available options to user based on findings.

### DESCRIPTION

In the following detailed description, numerous specific details are set forth in order to provide a thorough understanding of the invention. However, it will be apparent to one of ordinary skill in the art that these specific details need not be used to practice the invention. In other instances, well known structures, interfaces, and processes have not been shown in detail in order not to unnecessarily obscure the invention.

### Page Clipping System Overview

A system for capturing, storing, managing or processing a plurality of page clippings (e.g. sections of content of interest) from one or a plurality of pages of a digital publication comprises a processing device (e.g. a computer, a gaming device, a messaging device, a cell phone, a personal/portable digital assistant (“PDA”), an embedded device, or any other device capable of displaying content) which runs an operating system; an input device (e.g. a keyboard, a mouse, a microphone, a touch-screen, a remote control device, a speech activation device, or a speech recognition device or other input devices); an output device (e.g. a display, a computer monitor, a television screen, or other output device capable of displaying content); a stand-alone applications used to display the digital publication (e.g. reader, browser, plug-in, media player and other applications capable of displaying content), a digital publication application. The processing device includes a primary memory (e.g. RAM, etc . . . ) and may include a secondary memory such as a hard disk drive or removable storage drive. Both primary and secondary memories can store software components of system. Methods of system can be executed in whole or in part on the user's system, or in whole or in part on a remote system (e.g. server). In some implementations, the system may include a connection, for example, a simple wired or wireless connection to a device such as an external hard disk, or a network, such as, for example, the Internet. The invention can be implemented in digital electronic circuitry, or in computer hardware, firmware, software, or in combinations of them.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

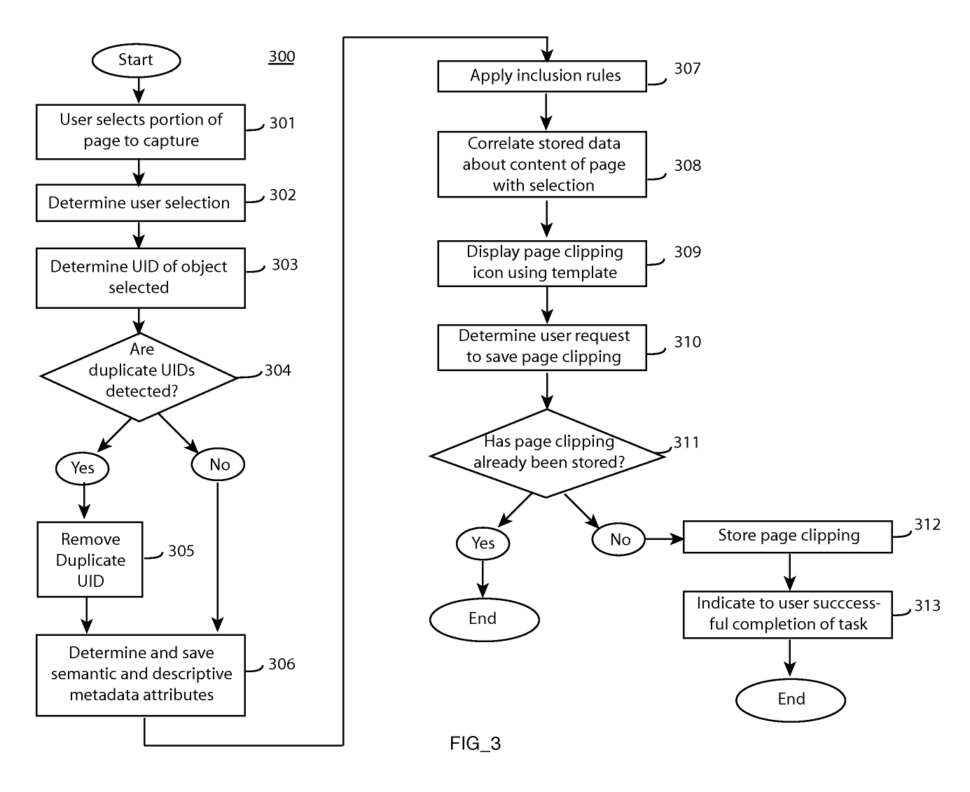

A system and methods for capturing, saving, managing, and processing a plurality of sections of a page (page clippings) or of a plurality of pages from a digital publication or from a plurality of digital publications can be implemented as one or more plug-ins that are installed and run on the processing device. The plug-ins are configured to interact with an operating system (e.g., MAC OS X, WINDOWS XP, LINUX, etc.) and to perform the various system and method functions, as described with respect of FIGS. 3 7. The said system and methods can also be implemented as one or more software applications running on the processing device. A system and methods for capturing, saving, managing, and processing a plurality of sections of a page (page clippings) can also be characterized as a framework or model that can be implemented on various platforms and/or networks (e.g., client/server networks, stand-alone computers, portable electronic devices, mobile phones, etc.), and/or embedded or bundled with one or more software applications (e.g., email, media player, browser, reader, etc.).

### Digital Publications

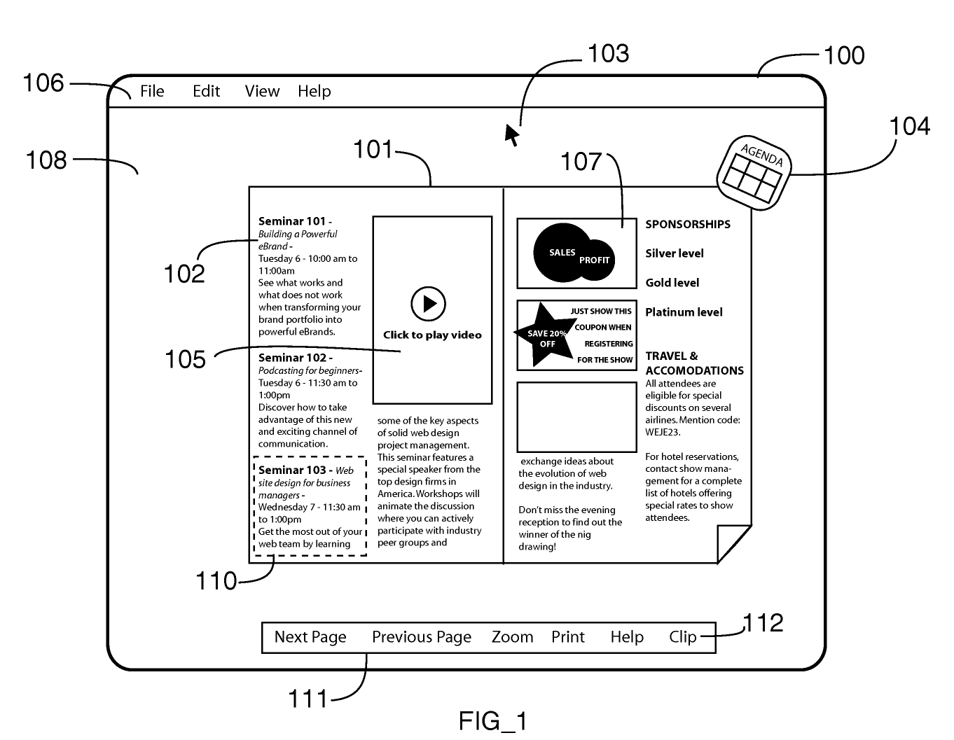

FIG. 1 illustrates a screenshot of an exemplary desktop user interface 100 with an exemplary digital publication 101. The desktop has a background image 108, menu bar 106, and other standard features. As is known in the art, the desktop may also include windows, icons, and other elements (not shown). For clarity purposes, the exemplary digital publication 101 is displayed in a windowless mode. In other words, the window and menu of the application running the digital brochure application (e.g. browser window, electronic document reader window, digital brochure player window, etc) is not shown to the user. In some implementations, digital publications can be displayed inside a window or in fullscreen mode whereby the desktop is no longer visible. The digital publication interface features a navigation bar 111 which includes several menu items and buttons for operating the brochure including a clip button 112. The navigation bar 111 may be positioned anywhere on the screen. In some embodiments, the digital publication 101 navigation bar 111 is optional. In other implementations, the navigation bar 111 can be dragged by user to any position on the screen. The screenshot also shows a software component 104, referred thereafter as publication component, that incorporates one or more tools (e.g. applications) that let the user perform specific tasks on the stored page clippings. The publication component 104 is represented on screen by an icon. In some implementations, no icon is presented. In this case, the user can invoke the tasks of the publication component by selecting an item from a menu or by clicking on a button, or by pressing a function key or key combination, or by some other means for invoking activation using s cursor 103 or not.

A digital publication page 109 is typically characterized by content objects, such as text 102, images 107, video clips 105, animations, audio files and the like, and layout or formatting information which defines the organization of the content, such as how the content objects appear when rendered for display to the user. Each content object can be assigned or associated with a unique identifier (e.g. variable value, instance name, reference, etc), referred thereafter as UID, at the time of creation in the application used to build the digital publication or during runtime when the digital publication is loaded into the system's memory. Such UIDs can be assigned to the actual content objects themselves or to overlay objects 110 (e.g buttons, graphical shapes or regions, hotzones, etc) that do not necessarily display content to users and serve to contain a UID. The overlay objects 110 can be visible (e.g button) or not (e.g. a transparent graphical region) to the user. Each content object can be associated with a corresponding overlay with a unique UID to allow the user to capture it. The overlay 110 may be positioned be on top of object or underneath object. It may be on same layer as object on another layer. It may be of the same size to cover to the object or of a different size and shape.

The use of overlay objects 110 may be necessary in digital publications in which a page is a graphics file where all objects on the page have been rasterized at the time of creation, preventing the identification of objects programmatically or the assignment of metadata to the object. The overlay 110 can be used to define the object size and position. In some implementations, the use of overlay objects is necessary to assign several UID to one object.

In some implementations, each content object or its corresponding overlay 110 can be assigned descriptive metadata attributes and or information about the semantics which further define the substance and meaning of the content at the time of creation of the digital publication and or at runtime. In some embodiments of the invention, descriptive metadata attributes and or semantically-rich description of information can be assigned to each object during the page clipping capture process. The nature and scope of the assigned information and attributes are based on the publication component 104 added to the digital publication, said publication component 104 determining the actions to be executed and the page clipping information needed. In other words, the descriptive metadata attributes and information about the semantics of objects must conform, at least in part, to an ontology defined by the publication component 104, so that each application component 104 has access to the information it needs about an object in its corresponding page clipping to perform processing tasks (e.g. meaning and or description must be relevant to the publication component's functions). In some implementations, only the UID info may be needed by a application component to perform its functions.

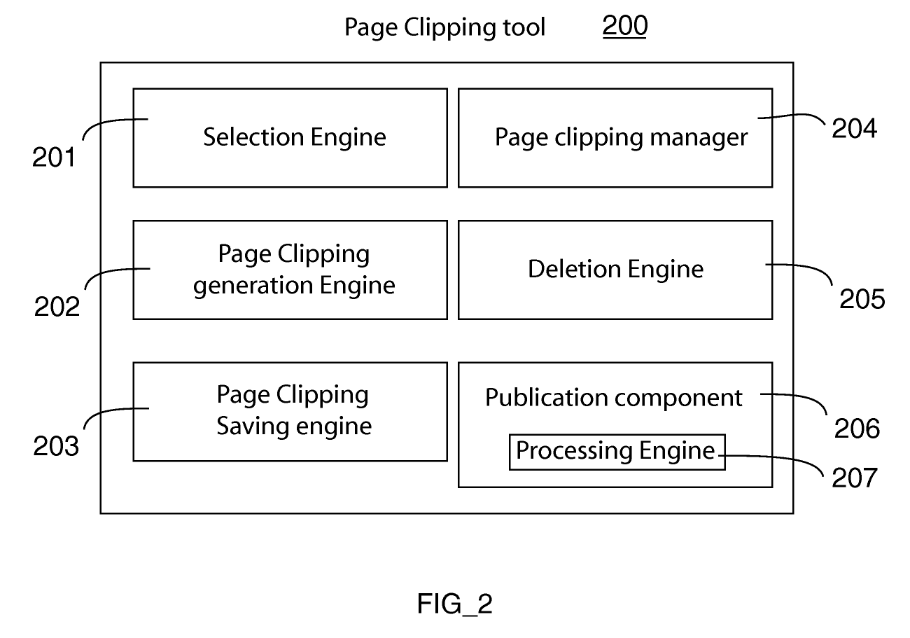

FIG. 2 illustrates a block diagram of an exemplary page clipping tool 200 which generally consists of several processes and engines 201 207 for selecting content of a page, generating a page clipping based on content selected, storing the page clipping, managing a set of stored page clippings and processing said set of page clippings based on the semantics of the content and or descriptive metadata attributes of the content or a combination thereof. Page Clipping tool 200 includes a selection engine 201, a page clipping generation engine 202, a page clipping saving engine 203, a page clipping manager 204, a deletion engine 205 and and a publication component 206 which itself includes a processing engine 207. In some embodiments, the page clipping tool may include more than one publication component 206. In some embodiments, all engines and processes may reside and run from the user's own system while in other embodiments parts or all engines and processes may reside and run from a remote computer or a removable disk such as a CD-ROM or DVD-R. Engines may reside outside the page clipping tool in other embodiments of invention.

As used herein, the term “process” and “engine” refer to a combination of functions, subroutines, procedure, subprogram, and the like that can be implemented in hardware, software, firmware or the like. The processes and engines can be separate processes or combined in another process. All can be a separate applications that are executable.

### Page Clipping Capture Process

Page clippings can be instantiated or created using a page clipping capture tool 200 which can consist of a selection engine 201, a page clipping generation engine 202, a saving engine 203, a deletion engine 205, a page clipping manager 204, and a processing engine 207.

Engines 201 207 are communicatively coupled to one or more of each other. Though the engines identified above are described as being separate or distinct, one or more of the engines may be combined in a single process or routine. The functional description provided herein including separation of responsibility for distinct functions is exemplary. Other groupings or other divisions of functional responsibilities can be made as necessary or in accordance with design preferences.

FIG. 3 describes the method 300 that may be used to capture, generate and store a page clipping. The method may be performed, at least in part, on the user's own processing device or on a remote server.

The method includes receiving the user selection 301 of the area of interest on the page 109 or pages displayed of the digital publication 101. The selection engine 201 determines the content objects 302 included in the selection area from 301. Each object is then associated with its UID 303. The selection engine 201 analyzes the collected UIDs to determine whether duplicates have been detected 304. For example, a UID could be assigned to several related content objects on a page when the objects cover the same topic, subject or have the same meaning. In such a situation, the duplicate UIDs need to be removed so that only one page clipping about the topic may be saved. The selection engine 201 proceeds to determining whether semantic data and descriptive metadata attributes have been assigned to the selected objects 305. Said data and attributes may have been built-in the content objects at the time of creation or assigned at runtime or when the publication was loaded into the processing device's memory. In some implementations, said data and attributes may reside on the user's own system, or a remote server or removable disk. Both data and attributes may be stored for the duration of the process or on a permanent storage device such as a flat file, relational database, or cookie. The selection engine 201 passes at least one parameter of the selected objects, for example the UID to the page clipping generation engine which applies rules of inclusion 307 to determine whether the page clipping can be stored. Depending on the publication component presented with brochure, the page clipping generation engine 202 may retrieve additional semantic data and descriptive metadata attributes about the object 308 to ensure that the publication component 206 will have access to all the information needed to perform its functions. The engine correlates stored data about the object with the UID. Data may be stored locally on the user's system or on a remote server. Relevancy is defined by the functions the publication component 206 will execute. If the preview option is required, the engine will load a predefined page clipping icon template and populate all relevant fields 309 with information collected in previous step 308. The engine monitors the user's request for storing the page clipping 310. Said request can come in many different forms, including dragging and dropping the page clipping icon on the publication component icon, choosing the save option in a confirmation window, etc. . . . The task of storing the page clipping in memory lies with the page clipping saving engine 203 which reads the result 311 of the inclusion rules 307 to determine where to save the clipping or not. The result of the inclusion rules may be that no matches were found which triggers the saving action 312 whereby the user is informed of the successful completion of the task 313. A result of match found ends the process.

In some implementations, operations 306 and 308 may be performed in the order listed or in parallel (e.g., by the same or a different process, substantially or otherwise non-serially). In some implementations, operations 306, 308, and 309 may be optional depending, at least in part, on whether the publication component 206 and or the page clipping generation engine 202 need data in addition to UID to perform their tasks and whether the preview option is required by the user or the page clipping tool 300.

### Selection Engine

The selection engine 201 is used to identify content on a page to be captured. The user can invoke the selection engine by selecting with her cursor 401 a section on a page and drawing a normal selection bounding box 406 around the content to be captured 400. The selection region can be a rectangular or non-rectangular shape, may be continuous or not. In other embodiments, the user can invoke the selection engine by hitting a designated keyboard function key or key combination after placing the cursor on the section to be captured; by invoking a contextual menu for the page section to be captured by hitting a designated keyboard function key or key combination or clicking on a mouse button; or by simply clicking on the object of interest or its corresponding overlay object. Other more straightforward methods are also possible whereby the user makes use of a special tool 402 in the navigation bar 403 of the digital publication 404 interface or the system's interface, or the digital publication reader application's interface to highlight a particular section of interest on a page or pages. In other embodiments, the user can simply click on a button associated with section to be captured or execute a specific mouse or input device movement on screen to select the area of interest. For example, the user can shake the mouse over a section of content; the engine analyzes in real-time the x and y coordinates of the cursor to determine whether a special motion has been detected and content selected for capture.

In response to the user input, the selection engine 201 determines the UID(s) associated with selected content 303, removes duplicate UIDs 304 and saves value(s) of the UID(s). The selection engine 201 also saves other metadata and semantics information, if any, contained or associated with said selected content 306.

The selection engine 201 passes at least one parameter, the UID, to the Page clipping generation engine 202. In some implementation, the functions performed by the page clipping generation 202 and page clipping saving engines 203 can be combined. In other words, the page clipping saving engine 203 can be the one receiving and collecting semantic and descriptive metadata attributes about the selected content for the generation of page clipping. In some embodiments, one or more UIDs are possible depending on the area of interest selected from the page. If the user's selection bounding box encompasses several content objects with different UIDs, the selection engines will collect all UIDs.

### Page Clipping Generation Engine

When invoked, the page generation engine 202 receives the UID or UIDs and applies inclusion rules 307 to determine whether the page clipping can be added to the stored set of page clippings and passed to the page clipping saving engine 203. The inclusion rules analyze the UID of every element, if any, already in the set of stored page clippings to determine whether the page clipping has already been included by comparing said values to the value passed from previous process and looking for a match. The result (e.g. match or no match found) of the inclusion rules iteration is saved for the duration of the current process. A match means that the page clipping has already been added to the set; a no match found means that the page clipping can be added.

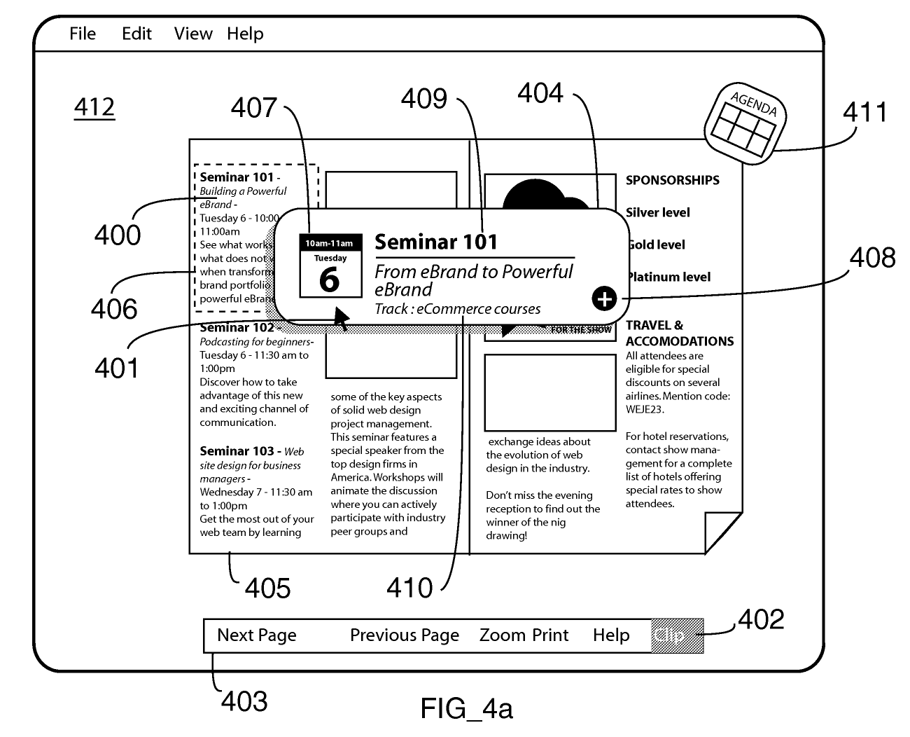

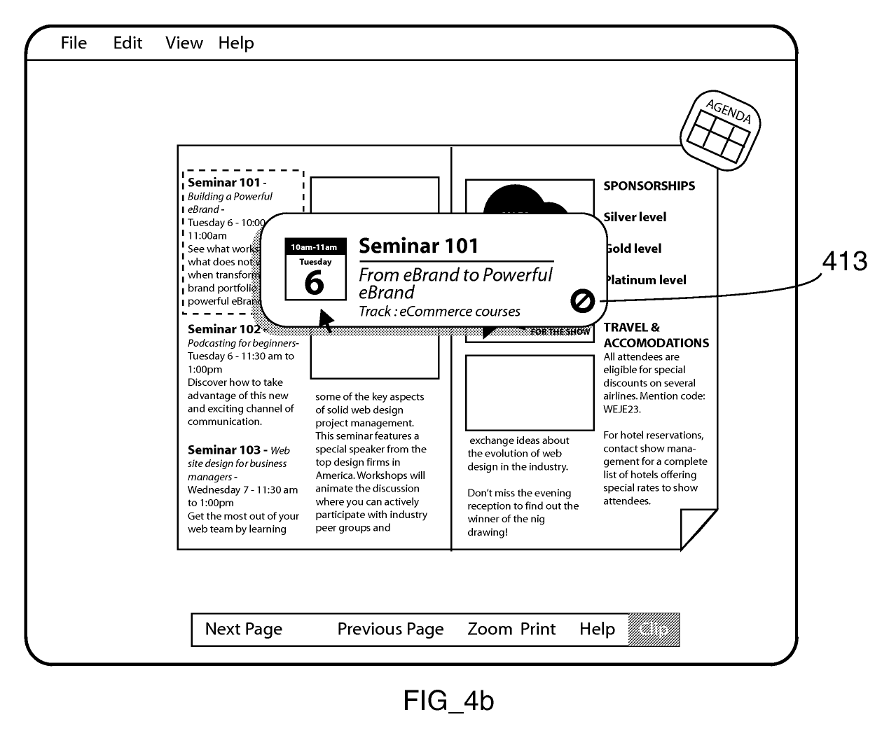

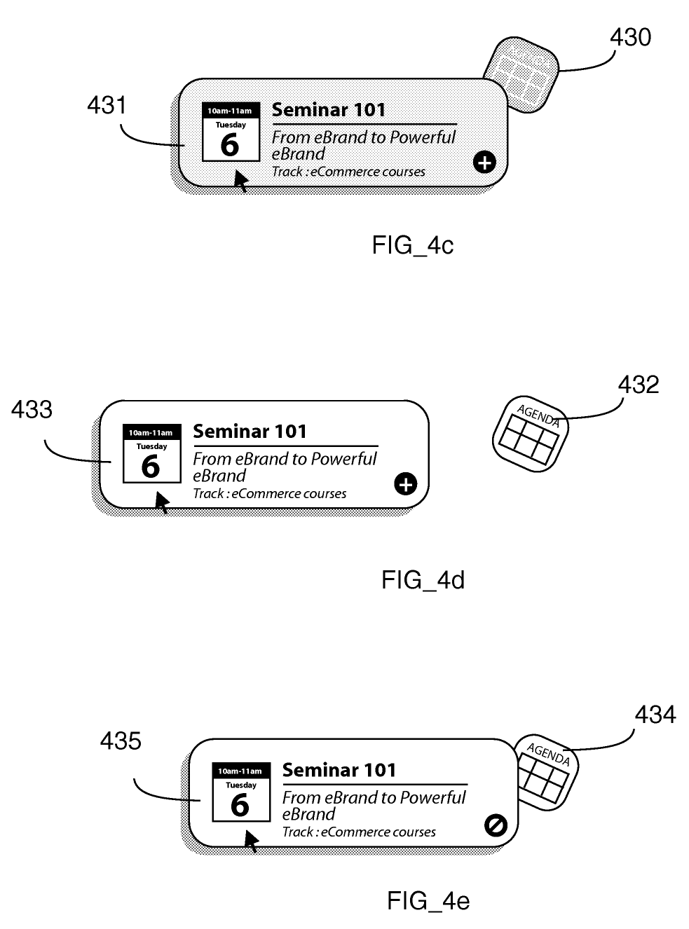

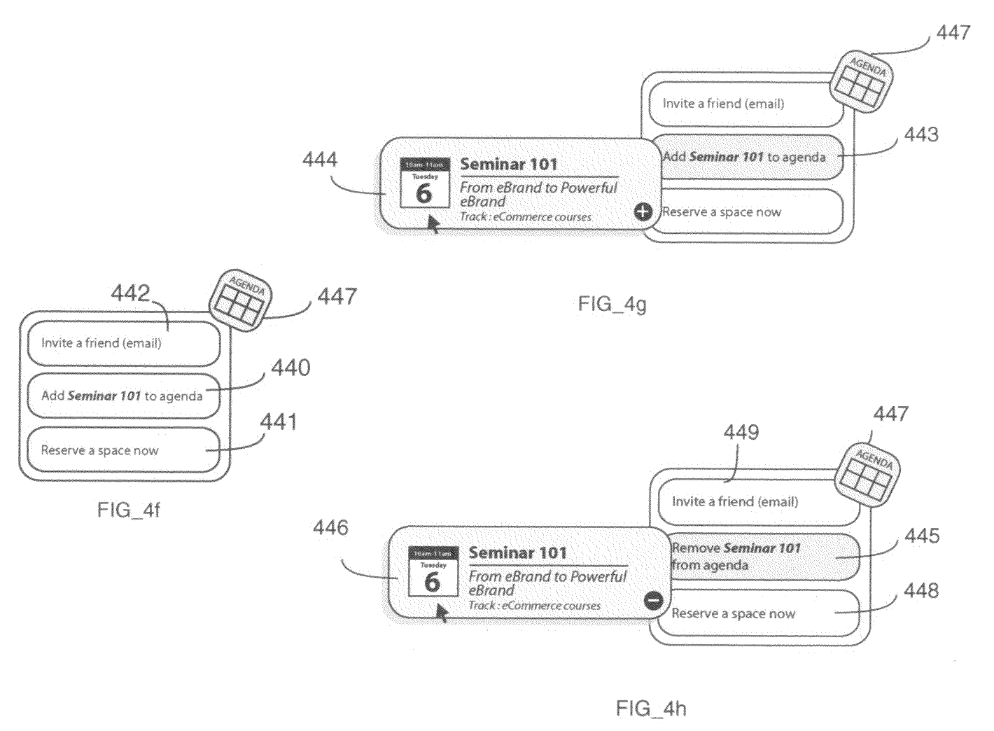

FIG. 4a illustrates a screenshot showing a page clipping preview icon 404 being displayed to the user as a result of selecting content 400 on a page 405. In some implementations, the content 400 can be selected by drawing a bounding box 406 around the area of interest 400 with the cursor 401. In other implementations, the user can choose the page clipping option 402 in the publication navigation bar 403 and draw a bounding box 406 around the area of interest 400. In another embodiment of the invention, the user can click with the cursor 401 on the area of interest 400. Other methods of selecting the area of interest are possible and have been highlighted in previous paragraphs.

Continuing with the method, if a preview option is selected or required (optional), the page clipping generation engine 202 prepares and displays a visual representation 309 (referred thereafter as page clipping preview icon 404) of the page clipping on the screen of the user. Said page clipping preview icon 404 can take the form of text label, a graphic or multimedia file or a combination thereof. Content 409 for the page clipping preview icon 404 can be retrieved by the page clipping generation engine 202 by correlating the passed UID with stored data (e.g. semantic data, descriptive metadata, etc . . . ) and elements (e.g. icons, pictures, videos, audio, Unified Resource Locators, RSS feeds, etc . . . ) 308 about each object of the digital publication 411. The stored data/elements may reside locally or on a remote server in relational database, flat-files, arrays, hashes, and other storage. In some implementations, content for the page clipping is passed from the selection engine 201 in the form of metadata and semantics information. The nature and scope of stored data can vary and depend on the functions the publication component 206 will need to execute on the page clippings. For example, a publication component 206 designed to produce a transcript of the video selected by a user will require the written version of spoken words of video as data. In another example, a publication component 206 designed to produce an annotated story board of a video to facilitate printing of the video on a sheet a paper will require text for captions and associated screenshots of the video. The publication component 206 will also need information or instructions about loading each screenshot if the screenshot files reside on a remote server.

In some implementations, a page clipping may contain more content and or data than the selected area of content 400 from which it was generated. For example, a page clipping of a video may contain the video file itself, a transcript of the video spoken words, hyperlinks to the web pages about the products featured in the video, semantic information, etc. . . . In some implementations, a page clipping may contain less content and or data than the selected area of content 400 from which it was generated. For example, if the publication component 206 only requires the UID of the object to execute its functions, the page clipping could be made up of only one parameter.

The engine arranges retrieved content using a predefined template for the page clipping preview icon 404. Such template can include placeholders for inserting the entire content selected or visual representation of the entire selected content, a summary of the content selected 409, additional information about the content selected 410, a graphic 407, multimedia content or a combination thereof. Several templates can be predefined to differentiate page clippings for different types of content objects of a digital publication. The templates can be stored on the user's own system or on a remote server. The templates can be loaded at compile time, runtime or dynamically as they are needed.

In some implementations, the page clipping preview icon 404 can also contain one or more element 408 such as a textual or graphical elements based on the outcome of the rules of inclusion 307 to indicate to user whether the page clipping can be included or has already been included. In FIG. 4a, the element 408 is a graphic featuring a plus sign (+) indicating that the page clipping can be added to the stored set of icon.

FIG. 4b represents a screenshot of a page clipping icon featuring a graphical element 413 indicating that the page clipping cannot be added and has already been included in stored set. The element 413 is illustrated by a graphic representing a forbidden sign. It is understood that such elements can take different shapes or be designed differently.

Coming back to FIG. 4a, the page clipping preview icon 404 becomes an element of the user interface with which the user can interact. The page clipping preview icon 404 can initially be placed underneath or next to the user's cursor 401, on top of the selection section of content or anywhere else on the screen. In some implementations, the page clipping icon can include a control that allows for the manual activation of the storing engine if the inclusion ruling result is a match not found. The activation can cause the display of a window (e.g., a confirmation window) to ensure appropriate behavior (e.g., add to agenda, delete clipping, etc . . . ).

In other implementations, the user can interact with the page clipping preview icon 404 by dragging the icon 404 to the publication component icon 411. Dropping the page clipping preview icon 404 on the component icon 411 triggers the activation of the storing engine if the inclusion ruling 307 result is a match not found. Dropping the page clipping preview icon 404 elsewhere on screen terminates the page clipping capture process and removes the page clipping preview icon 404 from the interface without invoking the page clipping saving engine 203. The page clipping generation engine 202 monitors the coordinates (x,y) of the page clipping preview icon 404 as the user drags the icon 404 to determine whether there is contact between said icon 404 and the publication component icon 411. Determination is done by analyzing the (x,y) coordinates, size of the bounding box of both icons 404 411. A bounding box is a rectangle that surrounds every object of a digital publication and defines it edges. Using the (x,y) coordinates and size of each icon's 404 411 bounding box, the page clipping generation engine 202 determines if the two bounding boxes intersect. Intersection is considered contact. FIGS. 4c, 4d and 4e illustrate the interaction between page clipping preview icon 404 and publication component icon 411. When icons 404 411 intersect, their states can be altered (darkened, highlighted, etc . . . ) 430 431 to indicate to the user that page clipping saving process 203 will be invoked if the page clipping preview icon 404 is dropped at this location in the event that the inclusion rules 307 returned a no match found value. Dragging the page clipping preview icon 404 away from the publication component icon 411 returns the visual states of the icons 404 411 to their original settings 432 433. When a match found value was returned by the rules of inclusion 307, the states of the icons 404 411 remain unchanged 435 436 even as they intersect to signal that no action will be triggered if the page clipping preview icon 404 is dropped at this location.

In some implementations, intersecting page clipping preview and publication component icons 404 411 can trigger the display of dropzones 440 441 as illustrated by FIG. 4f. The number and content of dropzones can vary based on publication component. Each dropzone 440 442 can trigger an action associated with the publication component when the user drops the page clipping preview icon 404 on one of the dropzones 440 442. A dropzone being a graphical shape with or without a label representing areas where the page clipping preview icon 404 can be dropped to invoke different processes. For instance, there could be a dropzone for saving a page clipping 440, emailing the page clipping 442, getting more information about the page clipping, etc. . . . The states of the dropzones can be altered to indicate intersection and signal that the action of dropping the page clipping preview icon 404 will trigger the execution of the function.

FIGS. 4g and 4h illustrate exemplary interactions between page clipping preview icon 404 and dropzones 440 442 of publication component icon 447.

When the rules of inclusion 307 returned a “no match found” result, intersecting the publication component icon 447 and the page clipping icon 444 can trigger the display of one or a series of dropzones 443 on or around the publication component icon 447. As the user drags the page clipping icon 444 on top of a dropzone 443, the visual state of the dropzone is altered indicating to the user that dropping the page clipping icon 444 at this location would trigger the execution of a function, in this case, “add the seminar 101 to the agenda”.

When the rules of inclusion 307 return “a match found” result, intersecting the publication component icon 447 and the page clipping icon 446 can trigger the display of an updated dropzone choice 445. In this instance, the new function “remove seminar 101 from agenda” is replacing the “add seminar 101 to the agenda” function because the page clipping can not be added to the stored set of page clippings. However, the user can invoke the deletion engine 205 by dropping the page clipping icon 446 on the updated dropzone 445 to delete the page clipping from the agenda (e.g. the stored set of page clippings). In this example, the visual state for the page clipping icon 446 has been altered because all presented dropzones 445 448 449 are available choices based on the “a match found” result. Other implementations of the visual state alterations are possible.

When dropzones are presented, dropping a page clipping icon 444 446 on a publication component icon 447 (e.g. not on its dropzone) can end the page clipping capture process.

Other methods for generating page clippings are possible. If a preview option is not selected or not required (optional), the page clipping generation engine 202 can pass the UID and other descriptive metadata attributes directly to the page clipping saving engine 203 if the result of the inclusion rules 307 is that no match was found. In other implementations, the page clipping generation engine 202 retrieves semantics information and descriptive metadata attributes about the selected section of content by correlating the UID with stored data about each object of the digital publication. The stored data may reside locally or on a remote server in a relational database, flat file, array, hash, cookie, and other file for persistent storage. Said information and metadata is then passed to the saving engine 203 for processing and saving.

In other implementations, the selection engine 201 can pass the UID(s) of selected objects directly to the page clipping saving engine 203 for processing and storing. In such instances, the page clipping saving engine 203 or selection engine 201 will apply the rules of inclusion 307 directly.

### Page Clipping Saving Engine

The page clipping saving engine 203 may be used for storing the UID, metadata attributes, related files (e.g. multimedia files, graphics files, images, icons, etc . . . ), or any other information passed by generation engine 202 or other engines or the page clipping manager 204. The page clipping saving engine 203 can add the page clipping 312 to the set of stored clippings by saving (e.g. copying, or moving to a volume, etc . . . ) the UID or UIDs of the selected object(s) they represent in an array, hash, data structure, table, list, etc. . . . Said UID, attributes, and files can be saved locally or remotely in a persistent storage device (e.g. user's processing device, external hard disk, remote server, etc . . . ). Once the page clipping is saved 312, the user is alerted of the successful completion of the task (e.g. storing of page clipping) 313. The alert can be the display of a confirmation window, playing a sound, etc. The page clipping generation process then ends.

At a minimum, the page clipping saving engine 203 will save one parameter, usually the UID, of the selected content object.

More than one publication component means that there may be more than one stored set of page clippings.

### Page Clipping Manager

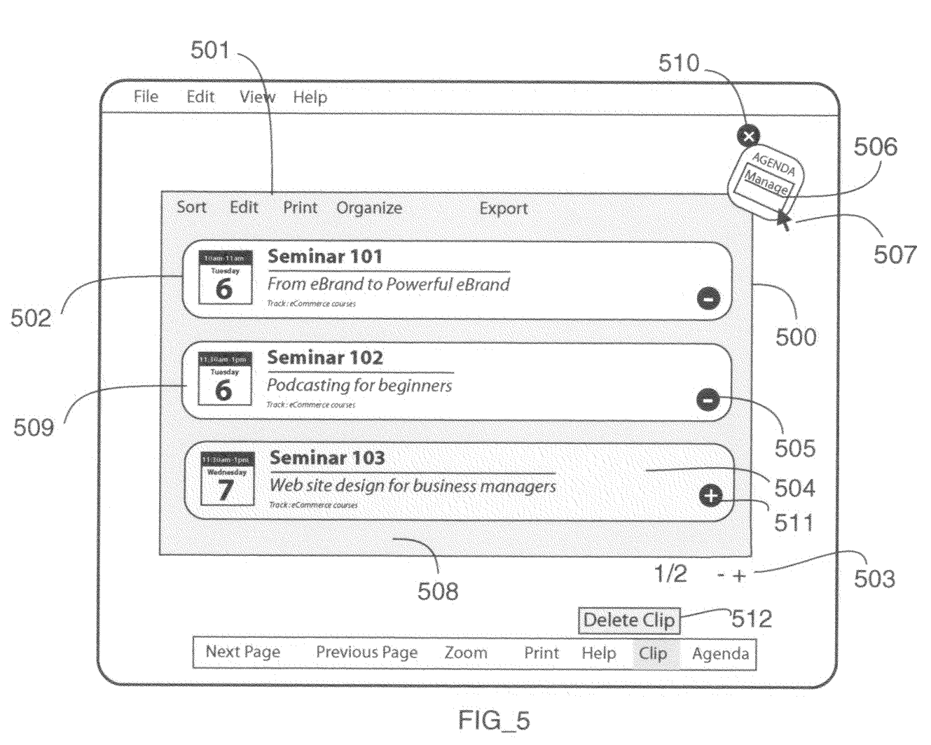

In some implementations, a page clipping manager 204 allows users to view, organize, delete, search, print sort the stored set of page clippings and add page clippings to the stored set of page clippings, referred thereafter as page clipping management functions, by displaying a page clipping management user interface. The page clipping manager 204 can be a preference pane, a stand-alone application, plug-in or a process. FIG. 5 illustrates a screen shot of an exemplary page clipping management user interface 500 that can be displayed by the page clipping manager 204. In one embodiment, the page clipping manager 204 displays the set of stored page clippings in a presentation screen 508 positioned on top of the digital publication. The page clipping management user interface 500 can feature a menu 501 providing access to the different page clipping management functions 501 as well as navigation tools 503 such as buttons to move to subsequent or previous display screens of the page clippings and screen number indicators. Others user interface elements are possible such as scroll bars or search fields. FIG. 5 shows a screen shot where three page clippings 502 are shown at a time. Users can click on the navigation button 503 to access the next screen of stored page clippings. Other arrangements are possible whereby more or fewer page clippings are shown per screen. The page clippings can all be shown at once using a scrollable screen (not shown).

The page clipping manager can be invoked by clicking on a menu item 506 in the publication component icon. Said menu item 506 can be permanently available to user or can be displayed only when user moves her cursor 507 over the publication component icon. Other methods of launching the page clipping manager are possible including invoking a contextual menu, hitting a designated keyboard function key or key combination, clicking on a button, or other input mechanism located on the user interface ( e.g desktop, system tray or dock, page clipping management interface 500), etc. . . .

Each stored page clipping is displayed using a page clipping icon 502 which may be different than the page clipping preview icon 404 displayed by the page generation engine 202 described earlier. In some implementations, said icons 502 and 404 can be the same. When the icons 502 404 are different, the page clipping manager will use another predefined template populated with information about the page clipping stored by the page clipping saving engine 203. In some embodiments, the page clipping icon may be populated with additional information and content retrieved after the page clipping process.

Each page clipping icon 502 can feature user interface elements 505 designed to facilitate the execution of certain page clipping management functions or invoking other engines 203 205 207. For example, page clipping icon 509 features a button 505 designed to remove said page clipping from the stored set of page clippings by invoking the deletion engine 205.

In some embodiments, more than one publication component may be used in a digital publication. In such situations, the page clipping manager 204 can use themed page clipping user interfaces 500 to differentiate the stored page clippings set for each component. For example, the interfaces 500 screens 508 can be of different color or display distinctive design elements such as special headers or graphics. Similarly, the page clipping templates for each theme can also be different. In other implementations, just one theme is used.

In some implementations, the page clipping manager 204 can perform additional functions such as monitoring content sources for possible updates of information or data regarding a selected object of content in the digital publication. Updated information is then passed to page clipping engine for storage 203 and displayed to user in page clipping icon 502.

In some implementations, the page clipping manager 204 and the page clipping user interface 500 can be dismissed by clicking a button 510 or menu item or other input mechanism.

### Deletion Engine

The deletion engine 205 provides control for removing page clipping after storing. The deletion engine 205 can be a separate process from the page clipping manager 204, or included therein. The deletion engine 205 can receive input and display user interface elements (dialogs and the like) to ensure that deletion operations are effectuated as required. The deletion engine 205 can be responsive to the selection of a user interface element, a portion of the element, controls associated with the element and the like.

In some implementations, the deletion engine 205 is invoked by clicking on a button 505 on the page clipping icon 509 displayed in the page clipping management user interface 500. Upon user input, the UID is removed from list of saved clippings. Other semantic information and descriptive metadata attributes can be removed.

The page clipping icon 509 can be immediately removed from the page clipping management user interface screen or its visual state can be altered (dimmed, darkened, blurred) 504 to signal that the page clipping is no longer part of the stored list. In some implementations, a button 511 is displayed on altered page clipping icon 504 to let user add the page clipping again. Upon activation of the button 504 or other input device, the UID is passed the page clipping storing engine for storage. Once the storing process is complete, the state of the page clipping icon in the page clipping management user interface 500 is reverted to original normal state 509.

In some implementations, the invocation of the deletion engine 205 can cause the display of a window (e.g., a confirmation window) to ensure appropriate behavior (e.g. remove page clipping, cancel, etc . . . ), immediate removal of page clipping icon from graphical user interface, immediate removal of unique identifier variable of each content object contained in page clipping from storage, removal of other information stored about each content object during page clipping process, deactivation of page clipping icon in graphical user interface and display of user interface elements to allow user to reactivate page clipping icon to reinitiate storage of content object unique identifier variable and other information. Other methods for deleting user interface elements are possible. A user can drag the page clipping icon 509 presented in the page clipping management user interface 500 outside of the list for deletion. The list is automatically updated and the page clipping deleted from the stored list. In other implementations, a user can drag the page clipping icon 446 to the publication component icon 447 to activate a dropzone 445 display and drop said icon of the remove clipping dropzone 445. Such implementation is possible from the page clipping management interface 500 and or from the digital publication interface 412. In other implementations of the invention, user can launch the deletion engine from a contextual menu invoked by right clicking on the page clipping icon 509. Other straightforward methods are possible. For instance, a user can click on a page clipping icon to select it and choose a menu item 512 from the digital publication navigation bar, etc. . . .

### Processing Engine—Publication Component

In some implementations, the invention consists of one or more publications components 206 that incorporate one or more tools (e.g. applications) to allow users to perform specific actions or functions, hereafter also referred to as component functions, on and provide fast access to information about the set of page clippings stored. In some embodiments, said publication components 206 can perform actions on individual page clippings. The publication component 206 can rely on a processing engine 207 to execute the functions associated with each action.

Said actions include, but are not limited to organizing clippings; printing a customized version of the digital publication based on stored list of page clippings formatted for sheets of paper; formatting the descriptive metadata attributes, content, and semantics information associated with or represented by page clippings to create a new document generated by a computer program locally on the user's own computer or mobile device or remotely on one or more server systems. In some implementations, the publication component 206 can include functionality that allows users to share descriptive metadata attributes, content, and semantics information from page clippings or content represented by page clippings with applications on remote servers or applications on user's own system for further processing or for completing a transaction; export the stored list of page clippings or content represented in clippings in a format compatible with mobile devices' applications. Said actions can be defined by the component itself and or by other engines in the page clipping capture tool.

The nature of actions can vary from publication component to publication component depending on the purpose of said components. In some embodiments, a digital publication can feature two or more publication components designed to process stored page clippings from the page clipping capture tool in different ways. For example, a real-estate digital publication featuring videos of showcase houses can incorporate two publication components that will process page clippings of the videos differently. After the user drops selected video objects using the selection engine on the first publication component, said component could execute an action to prepare a story board of video frames from the page clippings formatted for printing complete with captions listing the depicted house and room's snapshots specifications. As the user drops same selected video objects to the second publication component, said component could execute a function to prepare a series of new documents based on the stored page clippings, said new documents featuring construction plans of the house formatted for printing on regular ink jet printer, list of materials used in house, links to designer's and builder's web sites, links to special offers from vendors for materials used in the house, etc. . . . Actions and functions can be executed by the publication components' processing engines.

Processing engines can also retrieve additional semantics information, descriptive metadata attributes, and or other files if stored information is insufficient to perform specific actions of the publication components.

The publication component 206 can be a standalone application or a plug-in. Said component can be built-in the digital brochure file at the time of creation of the publication, or loaded at runtime, or imported by the user. In some implementations, the publication component may display a publication component user interface 600. In other implementations, the publication component can display user interface elements (dialogs and the like) to ensure that component functions are effectuated as required. In some embodiments, no user interface may be shown.

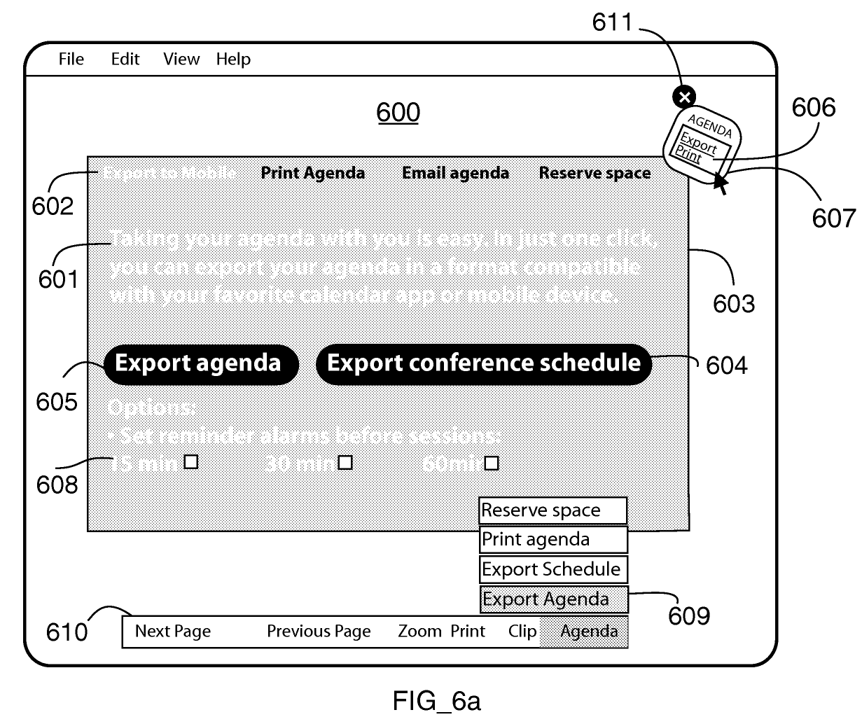

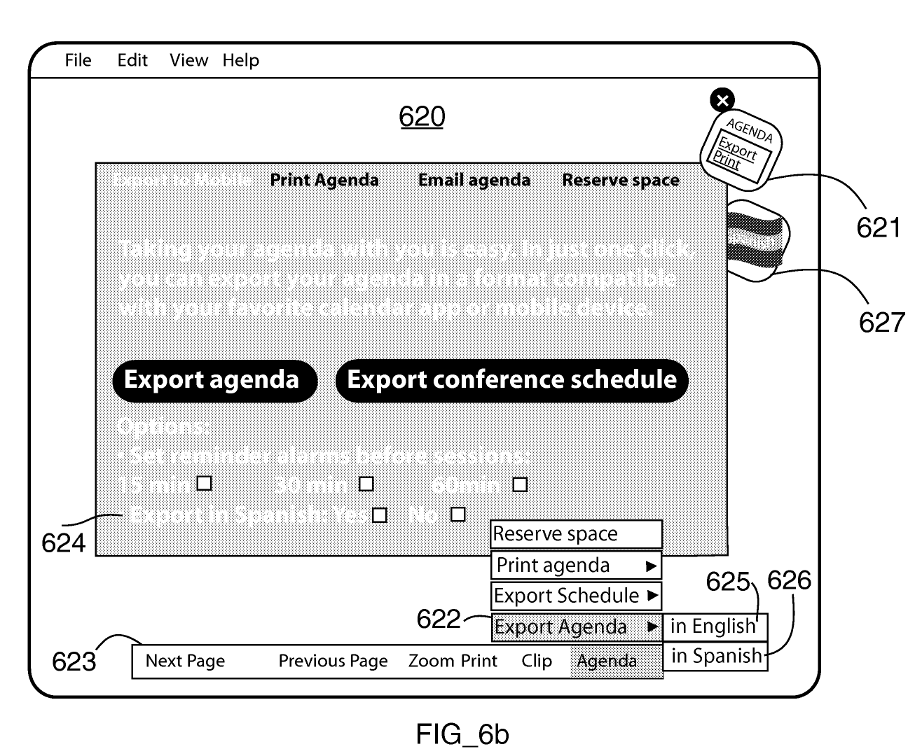

FIG. 6a illustrates an exemplary publication component user interface 600. It should be apparent that a user interface 600 for the publication component 206 can include more or fewer features than shown. In some implementations the user interface 600 can be displayed in another user interface (e.g. a desktop, digital publication layer or page clipping environment) in response to user input.

The publication component user interface 600 can be displayed to user when the user invokes the processing engine 207 or invokes one of the publication component's functions. Invocation can be done by selecting a menu item 609 in the digital publication navigation bar 610 or other navigation bar, by clicking on a button 606 on the publication component icon 607. Buttons 606 linked to functions of the publication component can be displayed along side the buttons 506 for the page clipping manager 204 that can also be displayed in the publication component icon 607 as illustrated in FIG. 5. Other invocation methods are possible. For example, the user can hit a special function key or key combination on her keyboard.

As discussed earlier, the publication component 206 can be represented on screen by a publication component icon 607. Said icon 607 can feature a menu 606 specific to the component's added functionality, giving the user quick access to all functions with a simple roll-over of the mouse. Said menu 606 can also be permanently displayed to the user and does not need a mouse-over activation. The icon 606 can be placed anywhere on the screen. It may or may not be part of the digital publication interface 600. In some implementations, the icon 607 may be made to appear and disappear when the user reads specific pages of the publication, indicating the presence of content on the displayed page which can be further processed by the publication component 206. In other embodiments, the icon 607 remains on the screen at all times. The icon 607 can be dragged by the user to another position on her screen.

A typical publication component user interface 600 can feature its own menu 602 which can list the menu items 606 displayed in the publication component icon 607 or display more or fewer choices. The menu 602 and other user interface elements can be shown on a screen 603 which may be superimposed on the digital publication. User interface 600 elements can include buttons 605 606 linked to specific functions of the publication component. The user can launch the execution of a given function by clicking on its corresponding button. For example, clicking on button 605 will execute the function to export the stored page clipping that represent agenda items to another format compatible with mobile devices or popular calendar applications. To assist the user, invocation of a function may trigger the display of a confirmation window to confirm decision to execute function and provide additional options (e.g. cancel, etc . . . ). A publication component user interface 600 can also feature instructions 601 to guide novice users through the process and options 608 to increase the usefulness of the digital publication and refine the requests made to the processing engine 207. Said options can be presented as part of the component user interface 600 default elements or may be added dynamically by the page clipping tool 200 due to the integration of a second publication component in the digital publication as illustrated in FIG. 6b. When the functions of different publication components 621 627 can be combined to offer new options for processing the stored set of page clippings, such options 624 626 can be presented to the user in the publication component user interface 620 of compatible publication components. For example, a digital publication for a conference may incorporate two different publication components. One component, such as the one 621 presented in FIG. 6b, can allow the user to build and export her own customized agenda. Another publication component 627 can provide the user with a spanish translation of stored page clippings. For example, a translation can be in text format or audio format dubbed over a clipped video. The functions of both components 621 627 can be combined whereby the user can export an agenda with descriptions in Spanish. In this case, the user interface 620 of the agenda publication component 621 can display options 624 626 to export the agenda of the user in Spanish. In implementations where no user interface is displayed to the user, the processing engine can build the option in the menu item choices 626. For example, the user could be presented with a navigator bar 623 menu item stating “Export agenda” 622 and a sub menu item entitled “in Spanish” 626. If a publication component user interface is displayed 620, the options can be listed directly on screen 624.

In some implementations, all components can be represented on screen with their own icons 621 627. In other implementations, part of the publications components may be represented on screen by icons while the other part may not.

In some implementations, the processing engine may create a subset of the stored set of page clippings to ensure that the functions are executed on the correct type of content. For example, if the user generated page clippings of seminar descriptions and video commercials of companies exhibiting at the conference, the processing engine would create a subset of the stored page clippings (e.g. the seminars) and only apply the functions to this subset. The subset can be stored for the duration of the process and deleted when the function has been executed. Other implementations are possible whereby the subset is stored as persistent data on a volume. In this case, the processing engine can update the stored subset if the set of page clippings changes when the user invokes the function again. A processing engine 207 can create several different subsets of the stored page clipping set to accommodate the different functions of a publication component 206.

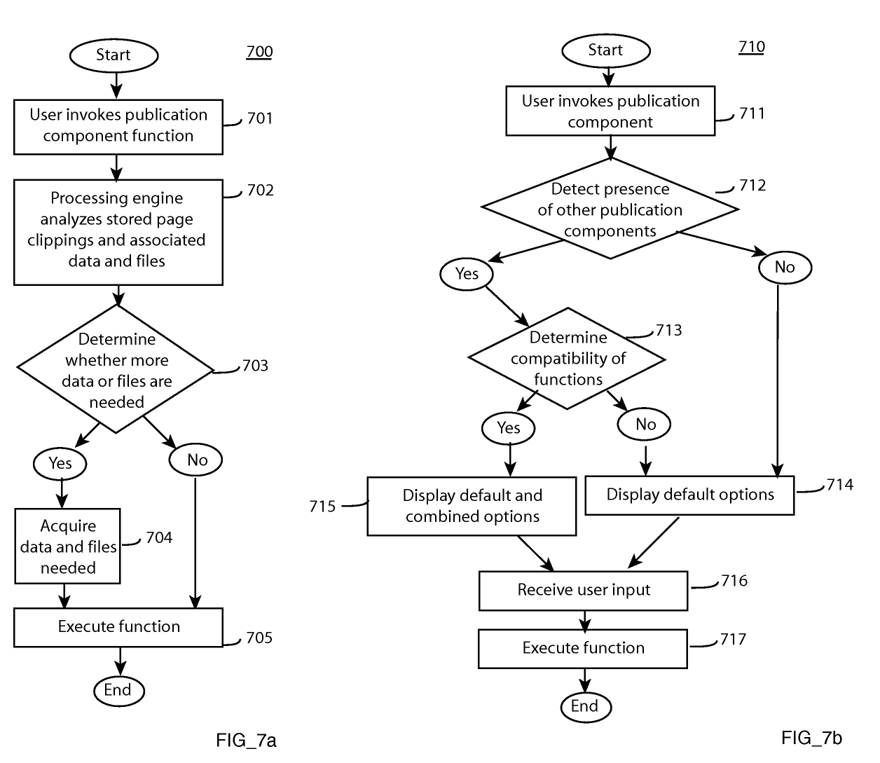

Upon invocation of a function, the processing engine 207 may perform additional tasks to ensure that the stored set of page clippings conforms to the requirement of said function. FIG. 7a illustrates a method 700 for ensuring such conformity. As the user invokes a publication component function 701, the processing engine 207 analyzes the stored page clippings and their associated data (e.g. semantics information, descriptive metadata, etc . . . ) and associated files to determine whether information 702 may be missing to execute the function successfully. If all the information required is available, the processing engine 207 proceeds with execution of function 705. If additional information is needed, the processing engine 207 can acquire missing information to complete the set of data 704. Only then can the engine 207 proceed to execute the function 705. Missing information can be retrieved from the user's own system, a removable hard disk such as a CD-ROM or DVD-R, or a remote server.

Upon invocation of a publication component 206, the processing engine 207 may perform additional tasks to maximize the usability and usefulness of the digital publication. For instance, as discussed earlier the processing engine 207 may detect the presence of additional publication components and assess whether their functions can be integrated with current component and present the new options in the user interface 610. FIG. 7b illustrates an exemplary method 710. The method may be initialized when the user invokes the publication component 711. Invocation can occur as the user clicks on a button of the publication component icon that links to one of its function. As seen earlier, other mechanisms of invocation are possible. The processing engine 207 seeks to determine the presence of additional publication components 712. This can be done by querying a registry, library, or a data structure listing available publication components. If no other publication component is found, the default options available for the publication component 206 can be displayed to the user 714. If other publication components are detected, the processing engine 206 can determine the compatibility of the functions of all available publications components 713. This can be done by comparing metadata classifying the publication components or by comparing the ontology of meaning of selected content, said ontology defined by each component. In other words, if the definition of meaning used by the publication component to describe the page clippings is the same then the functions of said publication components can be integrated (e.g. executed in parallel or in conjunction). If compatibility is not established, the default options for the publication component are displayed 714. If compatibility is established, new options are displayed along side the default options to the user 715. After the user selects the function she wants to execute 716, the processing engine 206 proceeds with the request 717.

In some implementations, the publication component user interface 600 can be dismissed by clicking a button 611 or menu item or other input mechanism.

1. A method of selecting, storing, and processing page clippings from a digital publication based on the meaning of the content selected, the method comprising the steps of: capturing a section of content of interest from a digital publication, creating a page clipping from the content selected, defining the meaning of page clipping, saving the page clipping, managing saved page clippings, and processing one or a plurality of page clippings.

2. A method of processing page clippings comprising one or more digital publication components that incorporate tools to allow the user to perform specific actions on stored page clippings and provide user with access to information about stored page clippings.

3. The method of claim 2 wherein actions comprise: organizing clippings; printing a customized version of the digital publication based on stored list of page clippings; formatting the descriptive metadata attributes, content, and semantics information associated with or represented by page clippings to create a new document; sharing descriptive metadata attributes, content, and semantics information from page clippings with another application for further processing or for completing a transaction; exporting the stored list of page clippings in a format compatible with mobile devices' applications.

4. The method of claim 1 wherein the content of a digital publication is composed of at least one of: text object, multimedia object, graphics object, audio object, video object or file object.

5. The method of claim 1 wherein each content object of a digital brochure is associated with a unique identifier variable.

6. The method of claim 5 wherein a unique identifier variable is assigned to actual content object.

7. The method of claim 5 wherein a unique identifier variable is assigned to an overlay object associated with a content object.

8. The method of claim 7 wherein the visibility property of the overlay is at least one of: true, wherein the overly is visible to the user or false, wherein the overlay is invisible to the user.

9. The method of claim 1 wherein each content object of the digital publication is assigned at least one of: descriptive metadata attributes or semantically-rich descriptive attributes.

10. The method of claim 1, where capturing a section of content of interest from a digital publication further comprises at least one of: A) drawing a bounding box around the portion of content to be captured, B) clicking over a content object to be selected, C) hitting a designated keyboard function key, D) hitting a keyboard key combination while placing the cursor over the section of content to be selected, or E) invoking a contextual menu associated with section of content to be selected.

11. The method of claim 1, where capturing a section of content further comprises: for each content object selected retrieving and storing semantic data, descriptive metadata attributes assigned to content object.

12. The method of claim 11 where at least one variable is retrieved and stored for each content object selected.

13. The method of claim 12 where the at least one variable is retrieved and stored is a unique identifier variable of each content object selected.

14. The method of claim 1, where defining the meaning of the page clipping further comprises: retrieving descriptive metadata attributes and semantically-rich information about each content object contained in page clipping.

15. The method of claim 14 wherein the nature and scope of the descriptive metadata attributes and semantically-rich information is determined by the digital publication's component and the actions the component will execute.

16. The method of claim 14 wherein the descriptive metadata attributes and semantically-rich information must conform, at least in part, to ontologies defined by the digital publication's component.

17. The method of claim 1, where storing a page clipping further comprises at least one of: applying inclusion rules to determine whether said page clipping can be stored; retrieving additional semantic data and descriptive metadata attributes about content objects selected in page clipping; correlating data with each selected object's unique identifier variable.

18. The method of claim 1, where creating a page clipping further comprises: loading a predefined page clipping icon template; populating page clipping icon template with relevant data about selected content object.

19. The method of claim 18 wherein a page clipping can be created without presenting a page clipping icon to the user.

20. The method of claim 1 where creating a page clipping further comprises: presenting a page clipping icon to the user.

21. The method of claim 20 where page clipping icon is a replica of selected portion of content.

22. The method of claim 20 where page clipping icon is at least one of: a text label, a graphic, or a multimedia object.

23. The method of claim 18 wherein relevancy of data to include in page clipping icon template is determined by the functions the digital publication's component will execute.

24. The method of claim 18 wherein populating page clipping icon template further comprises: correlating unique identifier variable each content object selected with stored data about the content object.

25. The method of claim 18 wherein data comprises: semantic data, descriptive metadata, icons, pictures, videos, audio files, RSS feeds, Unified Resource Locators (URLs), text, and email addresses.

26. The method of claim 1 wherein a page clipping can contain more data and information than the actual content objects from which it was created.

27. The method of claim 18 wherein several different page clipping templates can be loaded to reflect various types of content objects.

28. The method of claim 18 wherein populating page clipping icon template further comprises: incorporating textual or graphical elements based on the outcome of the rules of inclusion to indicate whether page clipping can be stored or not.

29. The method of claim 18 wherein the page clipping becomes a part of the user interface with which the user can directly interact.

30. The method of claim 1 wherein saving a page clipping further comprises: determining whether user has dragged and dropped page clipping on the digital publication's component dropzone, the dropzone being located on the component itself or next to the component; determining whether user has selected the save option from a contextual menu; reading the results of inclusion rules to determine whether to store page clipping.

31. The method of claim 30 wherein determining whether user has dragged and dropped page clipping on component further comprises: monitoring the x and y coordinates of page clipping as it is dragged by user.

32. The method of claim 30 wherein determining whether user has dragged and dropped page clipping on component further comprises: determining whether there is contact between page clipping and digital publication's component.

33. The method of claim 32 wherein determining whether there is contact between page clipping and digital publication's component further comprises: analyzing the x and y coordinates and sizes of the bounding boxes of the page clipping and digital publication component to determine whether the bounding boxes touch.

34. The method of claim 33 wherein the intersection of the page clipping and digital publication's component results in the alteration of the visual states of page clipping and digital publication when the result of the rules of inclusion is a no match found.

35. The method of claim 33 wherein the intersection of the page clipping and digital publication's component results in no alteration of the visual states of page clipping and digital publication when the result of the rules of inclusion is a match found.

36. The method of claim 33 wherein the intersection of the page clipping and digital publication's component results in the alteration of the visual states of page clipping and digital publication to indicate that dropping the page clipping will trigger an action.

37. The method of claim 33 wherein the intersection of the page clipping and digital publication's component triggers the display of a dropzone.

38. The method of claim 30 wherein dropping the page clipping on the dropzone of the digital publication's component triggers the display of another dropzone based on the result of the rules of inclusion.

39. The method of claim 30 wherein dropping the page clipping on the dropzone of the digital publication's component triggers the execution of an action.

40. The method of claim 30 wherein dropping a page clipping on an area other than the digital publication's component ends the page clipping capture process.

41. The method of claim 30 wherein the results of the inclusion rules can be match found or no match found, whereby match found means the page clipping cannot be stored while no match found means the page clipping can be stored.

42. The method of claim 41 wherein the inclusion rules comprise: comparing unique identification variable of each content object included in page clipping with the unique identification variables of each content object already stored in memory.

43. The method of claim 1 wherein saving page clipping consists of saving at least one variable about each content object contained in the page clipping selection.

44. The method of claim 43 wherein the at least one variable is the unique identifier variable.

45. The method of claim 1 wherein saving a page clipping further comprises: storing the semantics data, descriptive metadata, related multimedia files, related graphics files, images and icons associated with each content object contained in page clipping.

46. The method of claim 1 wherein saving a page clipping further comprises: retrieving additional data and files associated with each content object contained in page clipping.

47. The method of claim 1 wherein successfully storing the page clipping ends the page clipping generation process.

48. The method of claim 1 wherein managing page clippings further comprises: providing a graphical user interface to view, organize, delete, search, print, process and sort stored page clippings.

49. The method of claim 48 wherein the graphical user interface is displayed on top of the digital publication.

50. The method of claim 48 where page clippings are represented in the graphical user interface with icons different than the icons displayed during page clipping process.

51. The method of claim 48 where page clippings are represented in the graphical user interface using icons identical to the icons displayed during page clipping process.

52. The method of claim 50 wherein the page clipping icons are created using pre-defined templates populated with information about the page clipping stored during the page clipping generation process.

53. The method of claim. 52 wherein the page clipping icons are populated with additional information about the page clipping retrieved after the page clipping process.

54. The method of claim 50 wherein the page clipping icons feature user interface elements designed to execute functions.

55. The method of claim 48 wherein the graphical user interface can use different themes to differentiate page clippings corresponding to content objects.

56. The method of claim 1 wherein managing page clippings further comprises: monitoring content sources for updates of information or data about content object contained in a page clipping.

57. The method of claim 56 wherein updated information or data about content object is stored in page clipping and displayed to user in the graphical user interface of claim 21.

58. The method of claim 48 wherein deleting a page clipping comprises: immediate removal of page clipping icon from graphical user interface, immediate removal of unique identifier variable of each content object contained in page clipping from storage, removal of other information stored about each content object during page clipping process, deactivation of page clipping icon in graphical user interface and display of user interface elements to allow user to reactivate page clipping icon to reinitiate storage of content object unique identifier variable and other information.

59. The method of claim 3 where another application is on remote servers.

60. The method of claim 3 where another application is on user's own system.

61. The method of claim 2 wherein actions are defined by the digital publication's component itself and or by other engines in the page clipping capture tool.

62. The method of claim 2 wherein different components can process stored page clippings in different ways.

63. The method of claim 1 wherein processing one or a plurality of page clippings further comprises: retrieving additional semantically-rich information, descriptive metadata attributes, and other files about content objects contained in each page clipping if stored information is insufficient to perform specific actions of the publication components.

64. The method of claim 2 wherein the digital publication's component is at least one of: a standalone application, a plug-in, or an actual part of the publication user interface, part which is either built in the interface at runtime or at compile time.

65. The method of claim 2 wherein digital publication components are represented on screen by icons located anywhere on the digital publication, are draggable by the user, are set to be visible or invisible based on the pages accessed by user.

66. The method of claim 2 wherein digital publication components are represented on screen by icons located outside the digital publication interface.

67. The method of claim 65 wherein icon features a component menu listing the actions the component can execute.

68. The method of claim 2 wherein functions from different publication components can be combined to create new actions for the user to execute.

69. The method of claim 1 further comprising: storing page clippings in subsets.

70. The method of claim 2 wherein a digital publication component executes functions on a subset of stored page clippings.

71. The method of claim 1 wherein processing page clippings further comprises: performing additional tasks to ensure that stored page clippings conform to the requirement of the functions to be executed by digital publication component.

72. The method of claim 71 wherein performing additional tasks to ensure conformity further comprises: analyzing the stored page clippings and related stored data and information, determining whether data is missing to successfully execute function based on the requirements of digital publication component, retrieving missing data.

73. The method of claim 1 wherein processing page clippings further comprises: performing additional functions to maximize the usability and usefulness of the digital publication.

74. The method of claim 73 wherein performing additional functions further comprises: detecting the presence of other digital publication components, assessing whether functions of detected components can be integrated, presenting new options to user.

75. The method of claim 74 wherein assessing whether functions of detected components can be integrated comprises: comparing metadata classifying the publication components, comparing the ontology of meaning of selected content where the ontology is defined by each component.

76. A system comprising: means of selecting, storing, and processing page clippings from a digital publication based on the meaning of the content selected, the system comprising means of capturing a section of content of interest from a digital publication, means of creating a page clipping from the content selected, means of defining the meaning of page clipping, means of saving the page clipping, means of managing saved page clippings, and means of processing one or a plurality of page clippings.

77. A system of processing page clippings comprising: means for including one or more digital publication components that incorporate means to allow the user to perform specific actions of stored page clippings, means for providing user with access to information about stored page clippings.

78. The system of claim 76 further comprising: means for organizing clippings; means for printing a customized version of the digital publication based on stored list of page clippings formatted for A4 and letter-sized sheets of paper; means for formatting the descriptive metadata attributes, content, and semantics information associated with or represented by page clippings to create a new document generated by a computer program locally on the user's own computer or mobile device or remotely on one or more server systems, means for sharing descriptive metadata attributes, content, and semantics information from page clippings or content represented by page clippings with applications on remote servers or applications on user's own system for further processing or for completing a transaction; means for exporting the stored list of page clippings or content represented in clippings in a format compatible with mobile devices' applications.

79. A computer program product comprising instructions including instructions to cause a computing device to: select, store, and process page clippings from a digital publication based on the meaning of the content selected, the computer program further comprising instructions to cause a computing device to capture a section of content of interest from a digital publication, create a page clipping from the content selected, define the meaning of page clipping, save the page clipping, manage saved page clippings, and process one or a plurality of page clippings.

80. A computer program product comprising instructions to cause a computing device to: include one or more digital publication components that incorporate tools to allow the user to perform specific actions of stored page clippings, provide user with access to information about stored page clippings.

81. The computer program product of claim 79 further comprising instructions performing: organizing clippings; printing a customized version of the digital publication based on stored list of page clippings formatted for A4 and letter-sized sheets of paper; formatting the descriptive metadata attributes, content, and semantics information associated with or represented by page clippings to create a new document generated by a computer program locally on the user's own computer or mobile device or remotely on one or more server systems, sharing descriptive metadata attributes, content, and semantics information from page clippings or content represented by page clippings with applications on remote servers or applications on user's own system for further processing or for completing a transaction; exporting the stored list of page clippings or content represented in clippings in a format compatible with mobile devices' applications.
